(19) United States
(12) Patent Application Publication
(10) Pub. No.: US 2015/0253345 A1
(43) Pub. Date: Sep. 10, 2015

(54) TEST APPARATUS AND CONTROL METHOD THEREOF

(71) Applicant: SAMSUNG ELECTRONICS CO., LTD., Suwon-si (KR)

(72) Inventors: Ki Ju LEE, Suwon-si (KR); Im Ho SHIN, Suwon-si (KR)

(73) Assignee: SAMSUNG ELECTRONICS CO., LTD., Suwon-si (KR)

(21) Appl. No.: 14/637,527

(22) Filed: Mar. 4, 2015

(30) Foreign Application Priority Data
Mar. 4, 2014 (KR) 10-2014-0025548

(51) Int. Cl. G01N 35/00; B01L 3/00

(52) U.S. Cl. CPC G01N 35/00029; G01N 35/00722; B01L 3/5027; B01L 3/54; G01N 2035/00108; B01L 2300/021; B01L 2300/024; B01L 2200/10

(57) ABSTRACT

Provided are a test apparatus configured to detect a test item by using a reactor which includes a plurality of reaction units in order to detect a particular test item and a control method thereto. The test apparatus detects a detection result of one test item by using detection results obtained by two or more reaction units. The test apparatus includes a detection unit configured to detect reaction results of a plurality of reaction units provided in a reactor to detect the same test item, and a controller configured to calculate a test result which indicates the test item by using detection results obtained by at least two reaction units from among detection results of the detection unit.

### CROSS-REFERENCE TO RELATED APPLICATION(S)

This application claims priority from Korean Patent Application No. 10-2014-0025548, filed on Mar. 4, 2014 in the Korean Intellectual Property Office, the disclosure of which is incorporated herein by reference in its entirety.

### BACKGROUND

1. Field

Exemplary embodiments relate to test apparatuses which are configured for performing a test of a biological material by using a reactor, and methods for controlling the same.

2. Description of the Related Art

A microfluidic apparatus is an apparatus used to perform biological or chemical reactions by manipulating a small amount of a fluid.

In general, a microfluidic structure which is configured for performing one independent function in a microfluidic apparatus includes a chamber to contain a fluid, a channel through which the fluid flows, and a unit which is configured to control the flow of the fluid, and the microfluidic structure may be implemented by various combinations thereof. A lap-on-a-chip (LOC) is a device manufactured by arranging microfluidic structures on a chip-shaped substrate to perform a test including immunological and serologic reactions or biochemical reactions on a small chip and to perform multi-stage treatments and manipulations.

In order to cause a fluid to flow and to transfer a fluid in a microfluidic structure, driving pressure is required. As the driving pressure, capillary pressure or pressure generated using a separate pump may be used. In recent years, disc-shaped microfluidic apparatuses in which microfluidic structures are arranged on a disc-shaped platform and a series of operations are conducted while cause a fluid to flow by using a centrifugal force have been suggested. They are referred to as Lab CD or Lab-on-a-disk.

A microfluidic apparatus includes chambers or indicator paper used to detect a substance to be analyzed or tested.

The test apparatus, which is an apparatus used to detect results of biochemical reactions occurring in the chambers or indicator paper and including a light emitting unit and a light receiving unit to detect the chambers or indicator paper of the microfluidic apparatus, includes a blood tester.

### SUMMARY

Therefore, it is an aspect of one or more exemplary embodiments to provide a test apparatus configured to detect a test item by using a reactor which includes a plurality of reaction modules in order to discern a particular test item and a control method thereof. The test apparatus detects a detection result of one test item by using detection results obtained by two or more reaction modules.

Additional aspects of the exemplary embodiments will be set forth in part in the description which follows and, in part, will be obvious from the description, or may be learned by practice of the exemplary embodiments.

In accordance with one aspect of one or more exemplary embodiments, a test apparatus includes a detector configured to detect reaction results obtained by a plurality of reaction modules which are provided in a reactor in order to discern a first test item, and a controller configured to calculate a test result of the first test item by using detection results obtained by at least two reaction modules from among detection results detected by the detector.

The controller may store a detection result obtained by a first reaction module of the reactor and determine the stored detection result obtained by the first reaction module as a detection result which indicates the first test item when a detection result obtained by a second reaction module of the reactor corresponds to a value which is less than a reference value.

The controller may determine that the detection result which indicates the first test item is outside of a detection range when the corresponding value of the detection result obtained by the second reaction module is greater than the reference value.

The controller may store detection results obtained by a first reaction module and a second reaction module of the reactor and determine the detection result obtained by the first reaction module as a detection result which indicates the first test item when the detection result obtained by the first reaction module of the reactor corresponds to a value which is within a reference range.

The controller may determine the detection result obtained by the second reaction module as the detection result which indicates the first test item when the corresponding value of the detection result obtained by the first reaction module is outside of the reference range.

A detection range of the second reaction module may have a scope which is greater than a corresponding scope of a detection range of the first reaction module.

In accordance with another aspect of one or more exemplary embodiments, a reactor includes a plurality of reaction modules configured to detect a first test item, and a tag including at least one from among identification information which identifies the reactor and information which relates to a method for detecting the first test item.

At least one from among the plurality of reaction modules may include at least one from among an indicator paper and a chamber which includes a reactant configured to detect the first test item.

The information which relates to the method may include information which relates to at least one test method from among a plurality of predetermined different test methods for detecting the first test item.

The tag may include at least one from among a bar code, a quick response (QR) code, and a radio frequency identification (RFID) tag.

In accordance with a further aspect of one or more exemplary embodiments, a method for controlling a test apparatus includes detecting respective reaction results obtained by each of a plurality of reaction modules which are provided in a reactor for detecting a first test item, and calculating a test result of the first test item by using detection results obtained by at least two reaction modules from among the detected reaction results.

The calculating the test result may include storing a detection result obtained by a first reaction module of the reactor, determining whether a detection result obtained by a second reaction module of the reactor corresponds to a value which is greater than a reference value, and determining the stored detection result obtained by the first reaction module as the test result of the first test item when the corresponding value of the detection result obtained by the second reaction module is equal to or less than the reference value.

The method may further include determining that the detection result of the first test item is outside of a detection range when the corresponding value of the detection result of the second reaction module is greater than the reference value.

The calculating the test result may include storing detection results obtained by a first reaction module and a second reaction module of the reactor, determining whether the detection result obtained by the first reaction module is outside of a reference range, and determining the stored detection result obtained by the first reaction module as the test result of the first test item when the detection result obtained by the first reaction unit is determined as being within the reference range.

The method may further include determining the stored detection result obtained by the second reaction module as the test result of the first test item when the detection result obtained by the first reaction module is determined as being outside of the reference range.

In accordance with a further aspect of one or more exemplary embodiments, a non-transitory computer readable recording medium stores a program which is executable by a computer for performing the method.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 is a view schematically illustrating a structure of a disc-type reactor, according to an exemplary embodiment;

FIG. 2 is a view illustrating an appearance of a test apparatus configured to test the disc-type reactor, according to an exemplary embodiment;

FIG. 3 is a block diagram illustrating a configuration of the test apparatus, according to an exemplary embodiment;

FIG. 4 is a side view illustrating a configuration of the test apparatus, according to an exemplary embodiment;

FIG. 5 is a top view conceptually illustrating a detection module moving in a radial direction;

FIG. 6 is a view illustrating a reactor, according to another exemplary embodiment;

FIG. 7 is an exploded perspective view illustrating a test unit of the reactor of FIG. 6;

FIGS. 8 and 9 are views illustrating appearances of a test apparatus, according to still another exemplary embodiment;

FIG. 10 is a block diagram illustrating a configuration of the test apparatus, according to still another exemplary embodiment; and

FIGS. 11, 12, and 13 are flowcharts illustrating a method for controlling the test apparatus, according to an exemplary embodiment.

### DETAILED DESCRIPTION

Reference will now be made in detail to the exemplary embodiments, examples of which are illustrated in the accompanying drawings, wherein like reference numerals refer to like elements throughout.

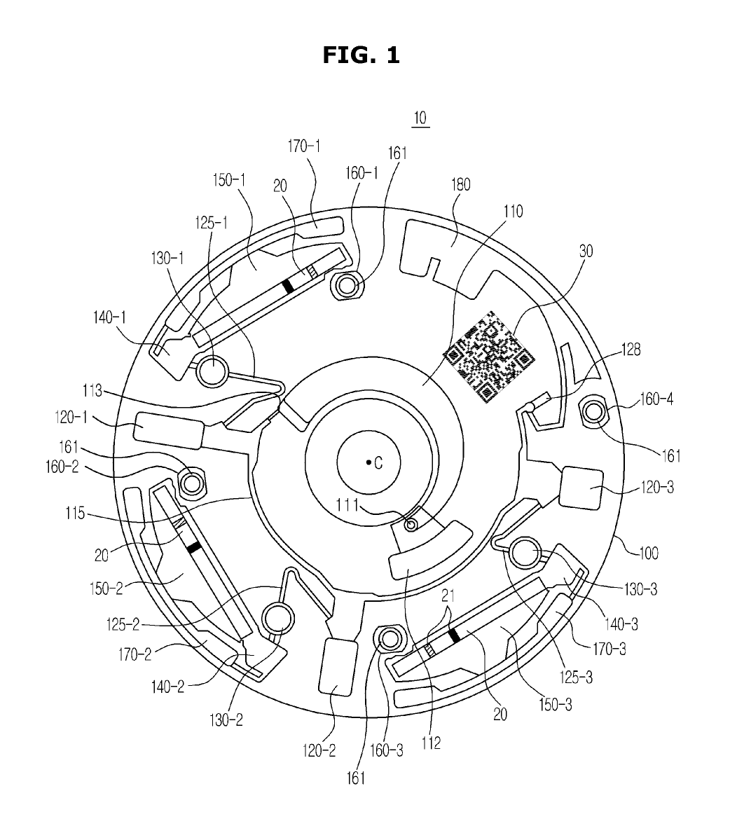

FIG. 1 is a view schematically illustrating a structure of a disc-type reactor, according to an exemplary embodiment.

Referring to FIG. 1, a disc-type reactor 10 according to an exemplary embodiment includes a platform 100 on which a microfluidic structure is formed and the microfluidic structure formed on the platform 100.

The microfluidic structure includes a plurality of chambers which are configured to accommodate a fluid and channels which connect the chambers.

The microfluidic structure is not limited to a structure having a particular shape, but comprehensively refers to a structure which includes a plurality of chambers and channels connecting the chambers and is formed on the platform 100 of the reactor 10 to facilitate the flow of a fluid. The microfluidic structure may perform different functions, depending on the arrangements of the chambers and the channels and types of the fluid accommodated in the chambers or flowing along the channels.

The platform 100 may be formed by using any one or more of various materials, which are easily molded and have biologically inactive surfaces, for example, plastic materials, such as acryl, e.g., polymethylmethacrylate (PMMA), polydimethylsiloxane (PDMS), polycarbonate (PC), polypropylene, polyvinyl alcohol, and polyethylene, glass, mica, silica, and silicon wafer. These materials are examples of materials used to form the platform 100 for the purpose of descriptive convenience, and exemplary embodiments are not limited thereto. Any material having chemical and biological stability, optical transparency, and mechanical porosity may also be used to form the platform 100.

The platform 100 may be formed in multiple layers of plates. Groove structures which correspond to microstructures such as chambers and channels are formed on the surfaces of two of the plates which are in contact with each other, and the plates are joined together so as to provide space for containing a fluid and a passage through which the fluid flows in the platform 100. The plates may be bonded to each other by using any one or more of various methods, such as adhesion using an adhesive or double-sided adhesive tape, ultrasonic fusion, and laser welding.

Although a disc-type platform 100 having a circular plate shape is used in FIG. 1, the platform 100 according to the illustrated exemplary embodiment may also have a self-rotatable disc shape, a fan shape rotatable in a state of being mounted on a rotatable frame, and/or any rotatable polygonal shape.

Since a fluid flow is caused by a centrifugal force in the reactor 10 according to the illustrated exemplary embodiment, chambers receiving the fluid are disposed at outer positions from the center of the platform 100 with respect to chambers supplying the fluid, which are disposed at positions which are nearer to the center of the platform 100.

The chambers are connected to each other via the channels. As illustrated in FIG. 1, at least one first chamber 120 may be connected to a distribution channel 115. For convenience of explanation, a case in which three first chambers 120 including a 1-1st chamber 120-1, a 1-2nd chamber 120-2, and 1-3rd chamber 120-3 are connected to the distribution channel 115 in parallel, and three second chambers 130 including a 2-1st chamber 130-1, a 2-2nd chamber 130-2, and a 2-3rd chamber 130-3 are respectively connected to each of the first chambers 120 will be described by way of example.

A sample supply chamber 110 is disposed at a closest relative position to a center of rotation C, and accommodates an externally supplied sample. The sample supply chamber 110 accommodates a sample in a fluid state. According to the illustrated exemplary embodiment, blood is supplied as the sample in a fluid state.

A sample introduction inlet 111 is provided at one side of the sample supply chamber 110, and blood may be introduced into the sample introduction inlet 111 by using an instrument such as a pipette. Blood may be spilled near the sample introduction inlet 111 during the introduction of blood, or the blood may flow backward through the sample introduction inlet 111 during rotation of the platform 100. In order to prevent the reactor 10 from being contaminated in this manner, a backflow receiving chamber 112 may be formed at a position which is adjacent to the sample introduction inlet 111 in order to accommodate any spilled sample during introduction thereof or any sample that flows backward.

As another example to prevent the backflow of the blood introduced into the sample supply chamber 110, a structure functioning as a capillary valve, which allows passage of the sample only when a pressure greater than or equal to a predetermined level is applied thereto, may be formed in the sample supply chamber 110.

Alternatively, as another example to prevent the backflow of the blood introduced into the sample supply chamber 110, a rib-shaped backflow prevention device may be formed in the sample supply chamber 110. When the rib-shaped backflow prevention device is formed in a direction which crosses the direction of the flow of the sample from the sample introduction inlet 111 to a sample discharge outlet 113, resistance is applied to the flow of the sample, thereby preventing the sample from flowing toward the sample introduction inlet 111.

The sample supply chamber 110 may be formed to have a width that gradually increases from the sample introduction inlet 111 to the sample discharge outlet 113 in order to facilitate discharge of the sample accommodated therein through the sample discharge outlet 113.

The sample discharge outlet 113 of the sample supply chamber 110 is connected to the distribution channel 115 formed on the platform 100 in a circumferential direction of the platform 100. The distribution channel 115 is sequentially connected to the 1-1st chamber 120-1, the 1-2nd chamber 120-2, and the 1-3rd chamber 120-3 in a counterclockwise orientation. A quality control (QC) chamber 128 which is configured to indicate completion of supply of the sample and an excess chamber 180 which is configured to accommodate any excess sample remaining after the supply of the sample may be connected to the end of the distribution chamber 115.

The first chambers 120 may accommodate the sample supplied from the sample supply chamber 110 and cause the sample to separate into a supernatant and a sediment as a result of the centrifugal force. Since the sample used herein is blood, the blood may separate into a supernatant which includes serum and plasma and a sediment which includes corpuscles in the first chamber 120.

Each of the first chambers 120-1, 120-2, and 120-3 is respectively connected to each of corresponding siphon channels 125-1, 125-2, and 125-3. As used herein, the term “siphon” refers to a channel that causes a fluid to move by using a pressure difference. In the disc-type reactor 10, the flow of the fluid through the siphon channel is controlled by using capillary pressure that forces the fluid to move up through a tube having a very small cross-sectional area and centrifugal force generated by rotation of the platform 100. In particular, an inlet of the siphon channel having a very small cross-section is connected to one chamber which accommodates the fluid, and an outlet of the siphon channel is connected to another chamber to which the fluid is transferred. In this regard, a point at which the siphon channel is bent, i.e., the highest point of the siphon channel, should be higher than a level of the fluid accommodated in the chamber. When the siphon channel is filled with the fluid by capillary pressure of the siphon channel, the fluid filling the siphon channel is transferred to a next chamber by centrifugal force.

As described above, the highest point of the siphon channel 125 should be higher than the highest level of the fluid in the first chamber 120. In order to secure the height difference, the 1-2nd chamber 120-2 is disposed along a circumference more distant from the center of rotation C of the platform 100 than the 1-1st chamber 120-1 or along a circumference having a larger radial distance from the center of rotation C, and the 1-3rd chamber 120-3 is disposed along a circumference more distant from or on a circumference having a larger radial distance from the center of rotation C than the 1-2nd chamber 120-2.

According to this structure, as one first chamber 120 is positioned farther away from the sample discharge outlet 113, the first chamber 120 has a shorter length in a radial direction. Thus, if required, one first chamber 120 which is positioned farther from the sample discharge outlet 113 may have a larger width in a circumferential direction in order to allow a plurality of first chambers 120 to have the same volume, as illustrated in FIG. 1.

As described above, the positions at which the inlets of the siphon channels 125-1, 125-2, and 125-3 meet the outlets of the first chambers 120-1, 120-2, and 120-3 may vary, depending on the amount of the fluid to be transferred. If the sample is blood as in the illustrated exemplary embodiment, a test is often performed only on the supernatant, and thus the outlets of the first chambers 120 may be arranged at upper portions where the supernatant is contained. In addition, protrusions may be provided at the outlets of the first chambers 120 in order to facilitate the flow of the fluid and connected to the siphon channels 125-1, 125-2, and 125-3. However, this is an exemplary embodiment, and if the sample is not blood or the test is performed on the sediment in addition to the supernatant, the outlets may be provided at lower portions of the first chambers 120.

The outlets of the siphon channels 125-1, 125-2, and 125-3 are respectively connected to the second chambers 130 (i.e., 130-1, 130-2, and 130-3). The second chambers 130 may only accommodate blood and/or may also perform pretreatments or primary reactions with respect to blood and/or perform a simple test prior to a main test by using a pre-stored reagent or reactant.

The second chambers 130-1, 130-2, and 130-3 are respectively connected to third chambers 140 (140-1, 140-2, and 140-3). According to the illustrated exemplary embodiment, the third chambers 140 are implemented by using metering chambers. Each of the metering chambers 140 serves to meter a fixed amount of blood accommodated in each of the second chambers 130 and supplies the fixed amount of blood to respective reaction units 150.

The residue in the metering chamber 140 which has not been supplied to the reaction unit 150, which includes first, second, and third reaction units 150-1, 150-2, and 150-3, may be transferred to respective waste chambers 170 (i.e., 170-1, 170-2, and 170-3).

The third chambers 140-1, 140-2, and 140-3 are respectively connected to the reaction units (also referred to herein as “reaction modules”) 150-1, 150-2, and 150-3. The reaction units 150-1, 150-2, and 150-3 are implemented by using chambers in the same manner as the first, second, and third chambers. Each of reaction units 150-1, 150-2, and 150-3 respectively includes a strip 20 for detecting the presence of an analyte through chromatography.

The strip 20 includes a thin porous membrane, such as cellulose, or indicator paper with micro pores or having a micro pillar shape upon which capillary pressure acts. When a biosample such as blood or urine is dropped on the indicator paper 20, the biosample flows due to capillary pressure. For example, if the analyte is antigen Q, and binding between the analyte and a first marker conjugate occurs in the second chamber 130, the biosample will contain a complex of antigen Q and the first marker conjugate. When the analyte is antigen Q, a capture material that is immobilized on a test line 21 may be antigen Q. When the biosample flowing according to the capillary pressure reaches the test line 21, the complex of the antigen Q and the first marker conjugate binds to antibody Q to form a sandwich complex. Thus, if the biosample contains an analyte, the analyte may be detected by the marker on the test line 21.

The indicator paper 20 contained in the first, second, and third reaction units 150-1, 150-2, and 150-3 according to the illustrated exemplary embodiment is not configured to detect different test items, but configured to detect a same test item. Thus, one reactor 10 may be used to detect one test item. Although the first, second, and third reaction units 150-1, 150-2, and 150-3 are used to detect the same test item, detection ranges or limits of detection concentrations for the test item may vary. For example, a detection range of the indicator paper contained in the second reaction unit 150-2 may be wider than that of the indicator paper contained in the first reaction unit 150-1 so as to detect a high concentration range which cannot be detected by the first reaction unit 150-1. Alternatively, the second reaction unit 150-2 or the third reaction unit 150-3 may be densely formed on the test line 21 of the indicator paper in order to determine errors of detection results caused by the hook effect in the detection results of the first reaction unit 150-1. The test apparatus according to the illustrated exemplary embodiment may detect a detection result of the test item by using detection results of a plurality of reaction units 150 disposed on the reactor 10, and this will be described below.

The reaction units 150-1, 150-2, and 150-3 are respectively connected to the waste chambers 170-1, 170-2, and 170-3, and the waste chambers 170-1, 170-2, and 170-3 accommodate wastes discharged from the reaction units 150-1, 150-2, and 150-3.

The platform 100 may be provided with magnetic body accommodating chambers 160 (i.e., 160-1, 160-2, 160-3, and 160-4) for position identification in addition to chambers in which a sample or residue is accommodated or a reaction occurs. Each of the magnetic body accommodating chambers 160-1, 160-2, 160-3, and 160-4 accommodates a magnetic body. The magnetic body accommodated in the magnetic body accommodating chambers 160-1, 160-2, 160-3, and 160-4 may include a ferromagnetic material, such as, for example, any one or more of iron, cobalt, and nickel, which have a high intensity of magnetization and form a strong magnet such as a permanent magnet, or a paramagnetic material such as any one or more of chromium, platinum, manganese, and aluminum which have a low intensity of magnetization and thus do not form a magnet alone, but may become magnetized when a magnet approaches thereto and increase the intensity of magnetization.

In addition, the reactor 10 may be provided with a tag 30 for identification of the reactor 10 which includes information which relates to a test method of the reactor 10. The tag 30 may include any one or more of a one-dimensional (1D) bar code, a two-dimensional (2D) bar code such as a quick reaction (QR) code, or a radio frequency identification (RFID) tag. The tag 30 may be attached to the surface of the disc without using a separate receiving unit (i.e., a separate receiver), and a detection module 59 of the test apparatus may read the tag 30 to identify the reactor 10 and determine the test method. If the tag 30 is an RFID tag, the detection module 59 may include an RFID tag reader.

The tag 30 may include identification information which relates to the reactor 10 and which indicates that the reactor 10 is a disc configured to detect one test item by using detection results of a plurality of reaction units 150. The tag 30 may also include information which relates to a test method for calculating a detection result with regard to the one test item by using detection results of the plurality of reaction units 150. For example, the tag 30 may include at least one test method selected from a plurality of test methods which plurality includes a first test method, which determines whether a detection result of the first reaction unit 150-1 has errors caused by the hook effect by using a detection result of the second reaction unit 150-2 in order to determine the detection result of the first reaction unit 150-1 as the detection result of the test item, and a second test method, which determines a detection result of the first reaction unit 150-1 or the second reaction unit 150-2 as the detection result of the test item depending on whether the detection result of the first reaction unit 150-1 corresponds to a value which is greater than a reference range. This will be described below in more detail.

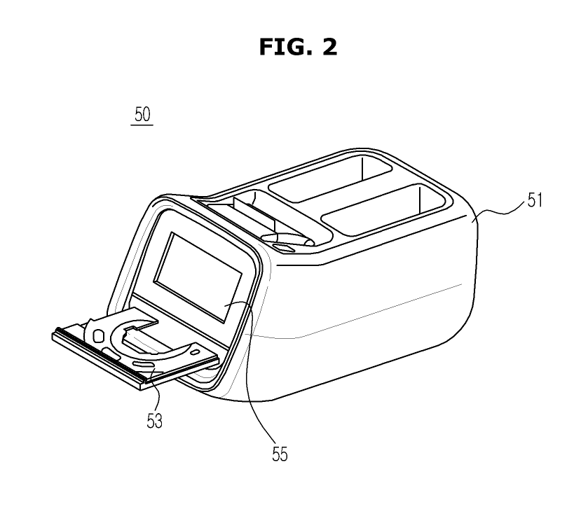

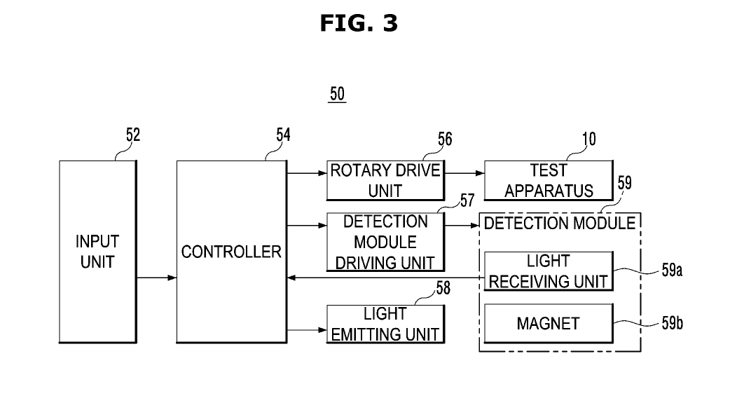

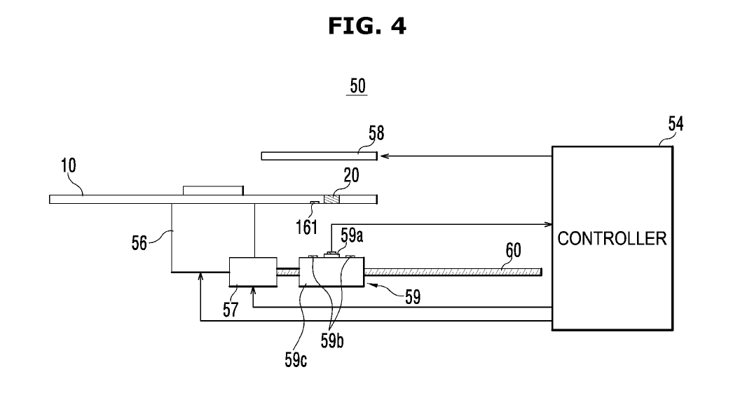

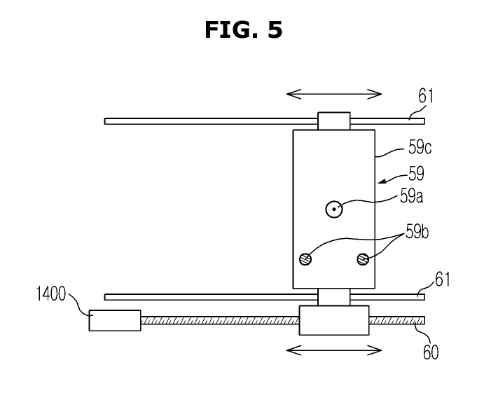

FIG. 2 is a view illustrating an appearance of a test apparatus which is configured to test the disc-type reactor 10. FIG. 3 is a block diagram illustrating the test apparatus. FIG. 4 is a side view illustrating a configuration of the test apparatus. FIG. 5 is a top view illustrating a detection module 59 moving in a radial direction.

Referring to FIG. 2, when the disc-type reactor 10 into which a sample is injected is loaded on a tray 53 installed in a test apparatus 50, and the tray 53 is inserted into a main body 51 of the test apparatus 50, the test apparatus 50 performs a test by rotating the reactor 10.

When a sample or reagent flows along each of the chambers and channels by centrifugal force and reactions occur in the reaction units 150 while the reactor 10 rotates, the reactor 10 moves the detection module 59 to positions which correspond to the reaction units 150, thereby detecting reaction results of the reaction units 150. After the test is completed, a detection result of a test item is displayed on a display unit (also referred to herein as a “display device” and/or as a “display”) 55 in order to inform the user of a test result.

Referring to FIG. 3, the test apparatus 50 includes a rotary drive unit (also referred to herein as a “rotary driver”) 56 configured to rotate the reactor 10, a light emitting unit (also referred to herein as a “light emitter”) 58 configured to emit light to the reactor 10, a detection module (also referred to herein as a “detector”) 59 including a light receiving unit (also referred to herein as a “light receiver”) 59a configured to read the tag 30 of the reactor 10 by using light emitted by the light emitting unit 58 or to detect indicator paper 20 contained in the reaction unit 150, a detection module driving unit (also referred to herein as a “detection module driver”) 57 configured to move the detection module 59 in a radial direction, an input unit (also referred to herein as an “input device”) 52 configured to receive an input of a user instruction from a user, and a controller 54 configured to control overall operation and function of the test apparatus 50 in accordance with the instruction received via the input unit 52.

The rotary drive unit 56 may be implemented using a spindle motor. When the reactor 10 is loaded, the rotary drive unit 56 is driven under a control of the controller 54, thereby causing the disc-type reactor 10 to rotate. The rotary drive unit 56 receives a signal which is output from the controller 54 and repeats rotation and stop operations so as to move the tag 30 or the indicator paper 20 to a desired position on the reactor 10.

The light emitting unit 58 may be implemented by using a surface light source which is capable of emitting uniform light to a wide area such that light is emitted to a predetermined area of the reactor 10. For example, a back light unit may be used as the light emitting unit 58.

The light emitting unit 58 may be disposed in the same direction as the light receiving unit 59a, or the light emitting unit 58 and the light receiving unit 59a may be disposed to face each other as illustrated in FIG. 4. Although the light emitting unit 58 is located over the disc-type reactor 10, and the light receiving unit 59a is located below the disc-type reactor 10 in FIG. 4, the positions thereof may also be exchanged. The light emitting unit 58 may control an amount of light emission in accordance with a control by the controller 54.

The light receiving unit 59a receives light emitted by the light emitting unit 58 and passing through the tag 30 or the indicator paper 20, thereby reading the tag 30 and/or detecting the indicator paper 20. The light receiving unit 59a may be implemented by using a complementary metal oxide semiconductor (CMOS) sensor and/or by a charge coupled device (CCD) sensor.

When an image of the tag 30 or the indicator paper 20 is received as the light receiving unit 59a receives light passing through the tag 30 or the indicator paper 20, the controller 54 may acquire information stored in the tag 30 by using the image and may detect a concentration of the test item based on the tone of color of the test line 21 of the indicator paper 20.

In the test apparatus 50 according to the illustrated exemplary embodiment, the light receiving unit 59a is installed in the detection module 59, which may move in a radial direction, such that one light receiving unit 59a may detect the tag 30 disposed on the reactor 10 and the plurality of pieces of indicator paper 20.

Referring to FIG. 5, the detection module 59 may move in a radial direction by driving force supplied by the detection module driving unit 57. The detection module driving unit 57 may be implemented by using a feeding motor and/or a stepping motor.

The detection module 59 may include a plate 59c on which constituent elements, such as the light receiving unit 59a and a magnet 59b, are mounted. The detection module 59 may move in a sliding motion in a radial direction by operation of two guide units (also referred to herein as “guide components” and/or as “guides”) 61 which guide a stable radial movement thereof. The guide units 61 may have a rod shape, and the plate 59c may be coupled to the guide units 61 and move along the guide units 61. The plate 59c that is mounted on the guide units 61 in a sliding manner may support the detection module 59 and enable the detection module 59 to move along the guide units 61.

In addition, the detection module 59 is mounted at a power transmission unit (also referred to herein as a “power transmitter”) 60 such that power generated by the detection module driving unit 57 is transmitted to the detection module 59 through the power transmission unit 60 to facilitate movement of the detection module 59 in a radial direction. In particular, when the detection module driving unit 57 is driven, and power is transmitted to the detection module 59 via the power transmission unit 60, the detection module 59 moves in a radial direction along the power transmission unit 60 and the guide units 61.

The magnet 59b provided at the detection module 59 applies attraction force to the magnetic body 161 accommodated in the magnetic body accommodating chambers 160 formed near the indicator paper 20 or the tag 20 in order to identify positions of the indicator paper 20 and/or the tag 30 of the reactor 10. According to the illustrated exemplary embodiment, the magnet 59b is installed at the detection module 59, and the magnetic body 161 is installed at the reactor 10. However, the exemplary embodiments are not limited thereto, and the magnetic body 161 may also be installed at the detection module 59, and the magnet 59b may also be installed at the disc-type reactor 10. When the magnet 59b of the detection module 59 faces the magnetic body 161 of the reactor 10, attraction force is applied from the magnet 59b to the magnetic body 161, and thus the position of the disc-type reactor 10 may be fixed unless force greater than the attraction force is applied thereto. The magnet 59b of the detection module 59 is positioned such that the indicator paper 20 faces the light receiving unit 59a of the detection module 59 when the magnetic body 161 of the reactor 10 faces the magnet 59b, and the position thereof is fixed by the attraction force applied thereto from the magnet 59b. In particular, as the magnetic body 161 of the reactor 10 faces the magnet 59b of the detection module 59, the indicator paper 20 naturally faces the light receiving unit 59a. As described above, in such a configuration in which the magnet 59b is installed at the detection module 59, while the reactor 10 rotates and moves toward the light receiving unit 59a for detection of the indicator paper 20, the magnetic body 161 approaching the magnet 59b is fixed at a position facing the magnet 59b by the attraction force applied by the magnet 59b, so that the reactor 10 is stopped in a state that the indicator paper 20 faces the light receiving unit 59a.

The controller 54 controls driving of the rotary drive unit 56 to rotate the reactor 10 and controls driving of the detection module driving unit 57 to move the detection module 59 in a radial direction, so that the light receiving unit 59a respectively detects the tag 30 and the reaction unit 150.

When the light receiving unit 59a acquires an image of the tag 30, the controller 54 reads the tag 30 and identifies the type of the reactor 10. If the reactor 10 is a reactor which includes one or more reaction units 150 configured to respectively detect different test items, the controller 54 calculates different detection results of the different test items based on each of the detection results of the reaction units 150 detected by the light receiving unit 59a.

According to the illustrated exemplary embodiment, if the reactor 10 is a reactor which includes one or more reaction units 150 configured to detect a same test item, the controller 54 calculates a detection result of the test item based on detection results of a plurality of reaction units 150 detected by the light receiving unit 59a. The detection results of the reaction units 150 configured to respectively detect different test items are not reliable when the detection result of each of the reaction units is outside of a detection range, or when a concentration lower than an actual concentration of the test item is calculated due to the hook effect. Accordingly, the reactor 10 according to the illustrated exemplary embodiment includes a plurality of reaction units 150 configured to detect the same test item, and the test apparatus achieves the detection result of the test item from which the error or concentration reduction is removed by using the detection results of the plurality of reaction units 150. Hereinbelow, this will be described in more detail.

The controller 54 reads the tag 30 and determines the type of the reactor 10.

As a result of reading of the tag 30, if the reactor 10 is a reactor which uses detection results of a plurality of reaction units 150 to calculate a result of one test item, the controller 54 controls driving of the rotary drive unit 56 and the detection module driving unit 57 to enable the light receiving unit 59a to respectively detect reaction results of each of the plurality of the reaction units 150.

Alternatively, as a result of reading of the tag 30, if the reactor 10 is a reactor to which a test method (hereinafter, referred to as first test method) is applied, the first test method including determining whether there is a detection error caused by the hook effect by using reaction results of the plurality of reaction units 150, and determining the detection result of the test item in accordance therewith, the controller 54 first stores the detection result of the first reaction unit 150-1.

In order to determine whether a reduction in the result caused by the hook effect occurs in the detection result of the first reaction unit 150-1, the controller 54 uses a detection result of the second reaction unit 150-2 as an auxiliary element. Indicator paper accommodated in the second reaction unit 150-2 (hereinafter, referred to as second indicator paper) may have a capture material, e.g., an antibody, at a high concentration on the test line 21 to capture the test item having a high concentration, in order to determine whether the detection result of indicator paper accommodated in the first reaction unit 150-1 (hereinafter, referred to as first indicator paper) is reduced due to the hook effect.

When the detection result of the second reaction unit 150-2 corresponds to a value which is less than a reference value, the controller 54 determines that the detection result of the first reaction unit 150-1 does not have an error caused by the hook effect, and thereby determines the detection result of the first reaction unit 150-1 as the detection result of the test item. Then, the controller 54 displays the result on the display unit of the test apparatus. When the corresponding value of the detection result of the second reaction unit 150-2 is greater than the reference value, the controller 54 determines that the detection result of the first reaction unit 150-1 is outside of the detection range detectable by the first indicator paper, and thus displays, on the display unit of the test apparatus, that the detection result of the test item is outside of the detection range.

If the detection result of the second indicator paper, which is configured to detect a range outside of the detection range of the first indicator paper without having the hook effect, is similar to the detection result of the first indicator paper, the detection result of the first reaction unit 150-1 may be determined as a normal value. However, if a value corresponding to the detection result of the second indicator paper is greater than the value corresponding to the detection result of the first indicator paper by a predetermined value or greater, it may be determined that the detection result of the first indicator paper has an error. The hook effect generally occurs when a sample includes a test item at a very high concentration. The reference value used to determine the existence of the hook effect may be set as a value similar to an upper limit of the detection range of the first indicator paper. The reference value may be pre-stored in the tag 30, and/or pre-stored in a memory (not shown) of the test apparatus.

Alternatively, as a result of reading of the tag 30, if the reactor 10 is a reactor to which a test method (hereinafter, referred to as second test method) is applied, the second test method including selecting the detection result of the test item from among reaction results of the plurality of reaction units 150, the controller 54 first stores detection results of the first reaction unit 150-1 and the second reaction unit 150-2.

When the second test method is applied to the reactor 10, respective pieces of indicator paper accommodated in the plurality of reaction units 150 have different detection ranges with respect to the same test item. For example, the detection range of the second reaction unit 150-2 may be greater than the detection range of the first reaction unit 150-1. For convenience of explanation, a description will be given of the second indicator paper having the detection range greater than the detection range of the first indicator paper.

The controller 54 determines whether the detection result of the first reaction unit 150-1 is outside of the reference range. In this regard, the reference range may be set within the detection range of the first reaction unit 150-1 and may be pre-stored in the tag 30 or a memory (not shown) of the test apparatus. When the detection result of the first reaction unit 150-1 is within the reference range, the controller 54 determines the detection result of the first reaction unit 150-1 as the detection result of the test item and displays the detection result of the first reaction unit 150-1 on the display unit.

When the detection result of the first reaction unit 150-1 is outside of the reference range, the controller 54 determines the detection result of the second reaction unit 150-2 as the detection result of the test item and displays the detection result of the second reaction unit 150-2 on the display unit. Using the detection results of two reaction units is described herein by way of example. However, the detection range of the test item may be enlarged by using detection results of two or more reaction units having different detection ranges.

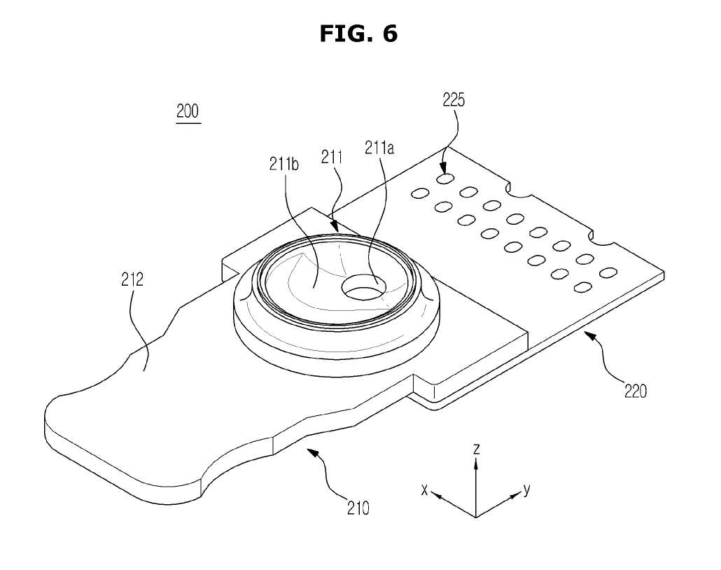

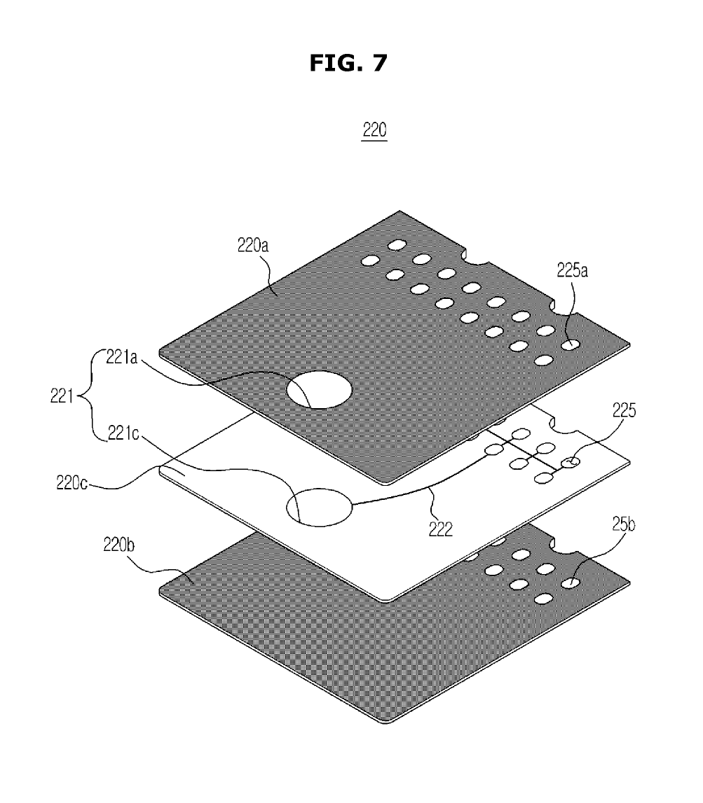

FIG. 6 is a view illustrating a reactor, according to another exemplary embodiment. FIG. 7 is an exploded perspective view illustrating a test unit of FIG. 6.

A reactor according to exemplary embodiments may include the aforementioned disc-type reactor 10 and a cartridge-type reactor 200, according to the current exemplary embodiment.

Referring to FIG. 6, the reactor 200 includes a housing 210 that supports the reactor 200 and a test unit (also referred to herein as a “tester”) 220 in which a reaction between a fluid and a reagent occurs.

The housing 210 includes a grasp portion 212 which is configured for being grasped by a user and a fluid accommodating unit (also referred to herein as a “fluid accommodator”) 211 configured to accommodate a fluid. The fluid accommodating unit 211 has a hole 211a through which the fluid may be introduced and a supply assisting portion 211b gradient to facilitate introduction of the fluid through the hole 211a. A filter may be provided in the hole 211a in order to remove corpuscles from blood when blood is introduced thereinto. The filter may be a porous polymer membrane formed of polycarbonate (PC), polyethersulfone (PES), polyethylene (PE), polysulfone (PS), polyaryl sulfone (PASF), or the like. For example, if blood is supplied as a sample, corpuscles are filtered while blood passes through the filter, and only plasma or serum may be introduced into the test unit 220. The test unit 22 includes a plurality of reaction units (also referred to herein as “reactors”) 225 in the forms of chambers in which the fluid introduced through the fluid accommodating unit 211 is accommodated. At least two of the plurality of reaction units 225 provided in the test unit 220 may contain a reagent to detect a same test item. Although not shown in the drawings, the test unit 220 may have a tag that stores information, such as identification information which relates to the reactor 200 and/or information which relates to a test method.

Referring to FIG. 7, the test unit 220 may have a structure in which three plates are joined. The three plates include an upper plate 220a, a lower plate 220b, and a middle plate 220c. The upper plate 220a and the lower plate 220b are coated with a lightproof ink, such that a sample being transferred to the reaction units 225 may be protected from external light.

The upper plate 220a and the lower plate 220b may be formed in a film shape. A film used to form the upper plate 220a and the lower plate 220b may be selected from the group consisting of polyethylene film formed of very low density polyethylene (VLDPE), linear low density polyethylene (LLDPE), low density polyethylene (LDPE), medium density polyethylene (MDPE), and high density polyethylene (HDPE), polypropylene (PP) film, polyvinyl chloride (PVC) film, polyvinyl alcohol (PVA) film, polystyrene (PS) film, and polyethyleneterepthalate (PET) film.

The middle plate 220c of the test unit 220, which is a porous sheet formed of cellulose and/or the like, may function as a vent. The porous sheet may be formed of a hydrophobic material, or may be subjected to a hydrophobic treatment so as not to affect the flow of the sample. The test unit 220 may include a sample introduction inlet 221, a channel 222 through which the introduced sample flows, and reaction units 225 in which reactions between the sample and the reagent occur. When the test unit 220 has a three-layered structure as illustrated in FIG. 7, the upper plate 220a may have an upper plate hole 221a constituting the sample introduction inlet 221 and transparent portions 225a corresponding to the reaction units 225.

In addition, the lower plate 220b may also have transparent portions 225b corresponding to the reaction units 225. The transparent portions 225a and 225b corresponding to the reaction units 225 may be used to measure optical properties caused by reactions occurring in the reaction units 225.

The middle plate 220c may also have a middle plate hole 221c constituting the sample introduction inlet 221. When the upper plate 220a, the middle plate 220c, and the lower plate 220b are joined, the upper plate hole 221a and the middle plate hole 221c overlap each other to form the sample introduction inlet 221 of the test unit 220.

Since the reaction units 225 are disposed at the opposite side with respect to the middle plate hole 221c of the middle plate 220c, regions of the middle plate 220c corresponding to the reaction unit 225 are molded to circular or rectangular shapes, and then the upper plate 220a, the middle plate 120b, and the lower plate 120c are joined, thereby forming the reaction units 225.

In addition, since a channel 222 having a width of 1 μm to 500 μm is formed in the middle plate 220c, a sample introduced through the sample introduction inlet 221 may flow to the reaction units 225 by capillary pressure of the channel 222. However, the width of the channel 222 is given by way of example applicable to the reactor 200, and exemplary embodiments are not limited thereto.

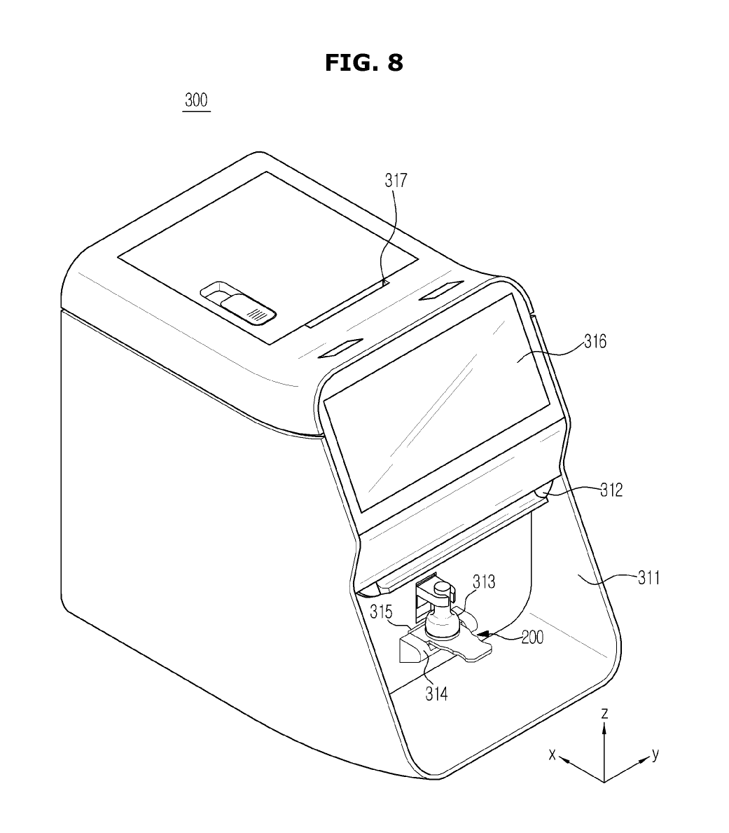

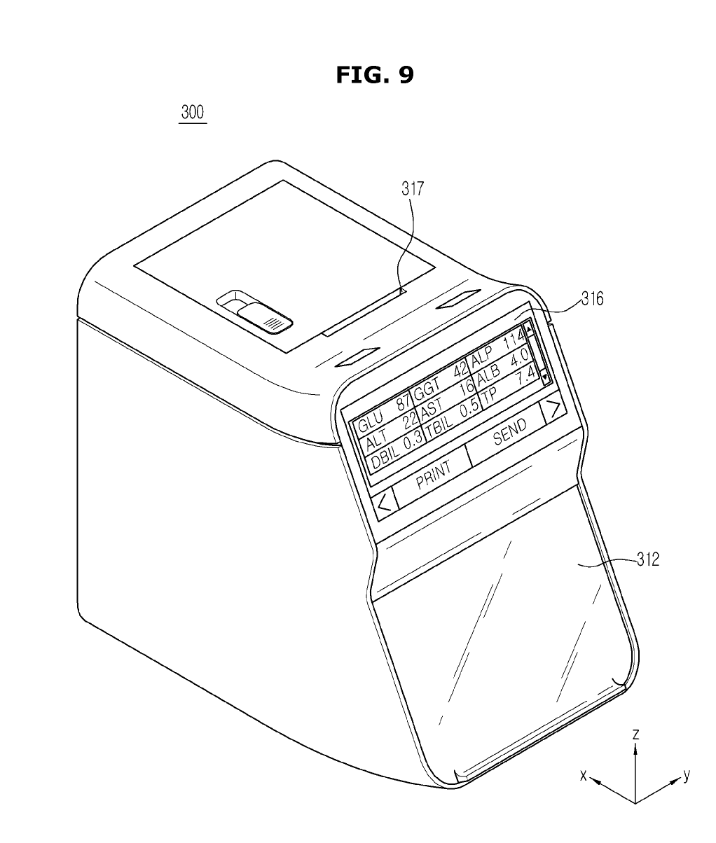

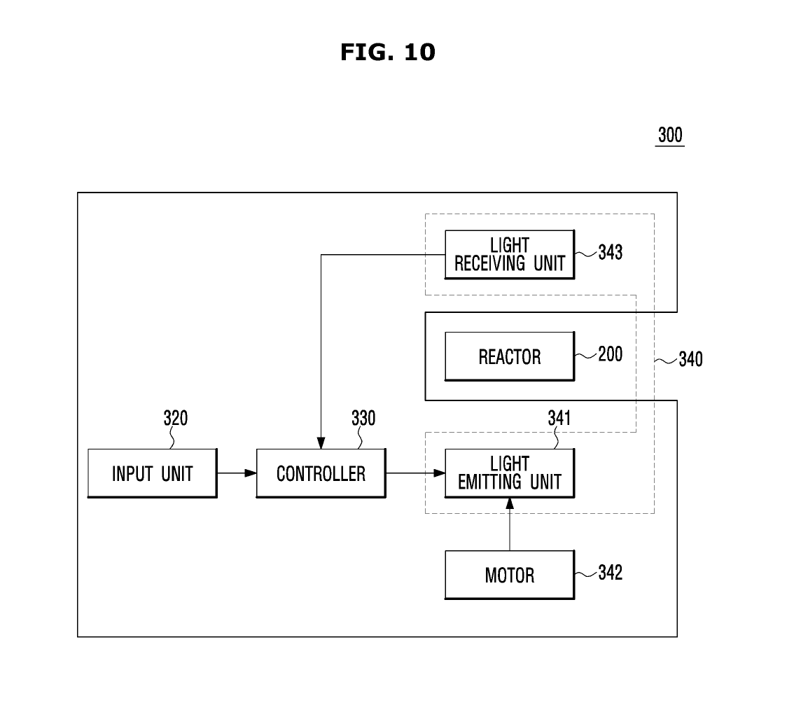

FIGS. 8 and 9 are views illustrating appearances of a test apparatus, according to still another exemplary embodiment. FIG. 10 is a block diagram illustrating a configuration of the test apparatus.

A reactor 200 is inserted into a test apparatus 300 as illustrated in FIG. 8.

The test apparatus 300 may include a mounting unit (also referred to herein as a “mounting portion” and/or as a “mount”) 311 on which the reactor 200 is mounted, a display unit (also referred to herein as a “display”) 316 to display test results of the reactor 200, and an output unit (also referred to herein as an “output device”) 317 in order to print out the test results as separate prints.

When a door 312 of the mounting unit 311 is opened by sliding the door 312 upward, the mounting unit 311 is exposed. The reactor 200 is mounted on the mounting unit 311 exposed by the open door 312. in particular, the reactor 200 is inserted into an insertion groove 315 such that the test unit 220 of the reactor 200 is inserted into the test apparatus 300.

As described above, the test unit 220 of the reactor 200 is inserted into the test apparatus 300, and the housing 210 is exposed to the outside of the test apparatus 300 in a state of being supported by a housing supporting unit 314. When a pressing unit 313 applies pressure to the fluid accommodating unit 211, the inflow of a sample introduced into the fluid accommodating unit 211 into the test unit 220 may be facilitated.

Further, after the reactor 200 is mounted, the door 312 is closed as illustrated in FIG. 9, and a test is initiated in the reactor 200.

As illustrated in FIG. 10, the test apparatus 300 includes a detection module 340 including a light emitting unit (also referred to herein as a “light emitter”) 341 and a light receiving unit (also referred to herein as a “light receiver”) 343.

The light emitting unit 341 of the detection module 340 may be implemented by using a surface light source which is capable of emitting uniform light to a wide area such that light is emitted to a predetermined area of the reactor 200. For example, a back light unit may be used as the light emitting unit 341. Alternatively, the light emitting unit 341 may include a light source that blinks at a predetermined frequency, and may be implemented by using a semiconductor light emitting device, such as a light emitting diode (LED) and/or a laser diode (LD), and/or by using a gas discharge lamp, such as a halogen lamp and/or a xenon lamp.

The light receiving unit 343 of the detection module 340 may detect light which is emitted by the light emitting unit 341 and which passes through or is reflected by the sample accommodated in a reaction chamber of the reactor 200, thereby generating an electric signal in accordance with an intensity of the light. The light receiving unit 343 may include any one or more of a depletion layer photo diode, an avalanche photo diode, a photomultiplier tube, and the like. Alternatively, the light receiving unit 343 may be implemented by using a complementary metal oxide semiconductor (CMOS) sensor and/or by a charge coupled device (CCD) sensor.

The light emitting unit 341 and the light receiving unit 343 may be disposed to face each other such that the reactor 200 is disposed therebetween, or may be disposed at the same side of the reactor 200, e.g., at an upper or lower portion of the reactor 200. According to the illustrated exemplary embodiment, the light emitting unit 341 and the light receiving unit 343 are disposed to face each other, and the reactor 200 is disposed therebetween. The detection module 340 may move in a direction toward a position at which a plurality of reaction units 225 are arranged in order to detect reaction results of the reaction units 225, and driving power to move the detection module 340 is provided by a motor 342 of the test apparatus. The controller 330 may control driving of the motor 342 so as to control the movement of the detection module 340.

An intensity and/or a wavelength of light emitted by the light emitting unit 341 may be adjusted by an instruction of the controller 330. The light receiving unit 343 may transmit the electric signal generated by detecting light to the controller 330. The detection module 340 may further include an analog-to-digital (AD) converter that converts the detection result of the light receiving unit 343 into a digital signal, and may output the digital signal to the controller 330.

When the sample introduced into the reactor 200 flows to a reaction unit 225 which includes a reagent used to detect a test item, the detection module 340 emits light to a reaction chamber under a control by the controller 330, detects light passing through the reaction chamber, and transmits a detected result to the controller 330. The controller 330 detects the existence of the test item or a concentration thereof by calculating absorbance based on the transmitted detection result.

After the test is completed, a set of test results is displayed on the display unit 316 of the test apparatus 300, as illustrated in FIG. 9. Since the reactor 200 includes a plurality of reaction units 225 as illustrated in FIG. 9, a plurality of test items may be detected by using one single reactor 200. When the plurality of test items are detected, the display unit 316 displays detection results of the plurality of test items as illustrated in FIG. 9. According to the illustrated exemplary embodiment, at least two reaction units 225 among the plurality of reaction units 225 may be configured to detect the same test item.

As the controller 330 controls driving of the motor 342 so as to move the detection module 340, the light receiving unit 343 may detect the tag and the reaction units 225, respectively.

When the light receiving unit 343 acquires an image of the tag, the controller 330 reads the tag and identifies the type of the reactor 200. If the reactor 200 is a reactor which includes one or more reaction units 225 configured to respectively detect different test items, the controller 330 calculates different detection results of the different test items based on each of the detection results of the reaction units 225 detected by the light receiving unit 343.

If the reactor 200 is a reactor which includes at least two reaction units 225 configured to detect the same test item, the controller 330 calculates a detection result of the test item based on the detection results of the plurality of the reaction units 225 detected by the light receiving unit 343. The detection results of the reaction units 225 configured to respectively detect different test items are not reliable when the detection result of each of the reaction units is outside of a detection range or a concentration lower than an actual concentration of the test item is calculated due to the hook effect. Accordingly, since the reactor 200 according to the illustrated exemplary embodiment includes a plurality of reaction units 225 configured to detect the same test item, the test apparatus achieves the detection result of the test item from which the error or concentration reduction is removed by using the detection results of the plurality of reaction units 225. Hereinbelow, this will be described in more detail.

The controller 330 reads the tag and determines the type of the reactor 200.

As a result of reading of the tag, if the reactor 200 is a reactor which uses detection results of a plurality of reaction units 225 to calculate a result of one test item, the controller 330 controls driving of the motor 342 to enable the light receiving unit 343 to respectively detect reaction results of the at least two reaction units 225 configured to detect the same test item.

Alternatively, as a result of reading of the tag, if the reactor 200 is a reactor to which the first test method is applied, the first test method including determining whether there is a detection error caused by the hook effect by using reaction results of the plurality of reaction units 225, and determining the detection result of the test item in accordance therewith, the controller 330 first stores a detection result of a first reaction unit.

In order to determine whether the detection result of the first reaction unit is reduced by the hook effect, the controller 330 uses a detection result of a second reaction unit as an auxiliary element. In order to determine whether a detection result of first indicator paper is reduced by the hook effect, second indicator paper may include a capture material, e.g., an antibody, at a high concentration on the test line 21 to capture a test item having a high concentration.

When the detection result of the second reaction unit corresponds to a value which is less than a reference value, the controller 330 determines that the detection result of the first reaction unit does not have an error caused by the hook effect and determines the detection result of the first reaction unit as the detection result of the test item. Then, the controller 330 displays the result on the display unit of the test apparatus. When the value corresponding to the detection result of the second reaction unit is greater than the reference value, the controller 330 determines that the detection result of the first reaction unit is outside of a detection range detectable by the first indicator paper and displays, on the display unit of the test apparatus, that the detection result of the test item is outside of the detection range.

If the detection result of the second indicator paper, which is configured to detect a range out of the detection range of the first indicator paper without having the hook effect, is similar to the detection result of the first indicator paper, the detection result of the first reaction unit may be determined as a normal value. However, if the detection result of the second indicator paper is greater than the detection result of the first indicator paper by a predetermined value or greater, it may be determined that the detection result of the first indicator paper has an error. The hook effect generally occurs when a sample includes a test item at a very high concentration. The reference value used to determine the existence of the hook effect may be set as a value similar to an upper limit of the detection range of the first indicator paper. The reference value may be pre-stored in the tag and/or pre-stored in a memory (not shown) of the test apparatus.

Alternatively, as a result of reading of the tag, if the reactor 200 is a reactor to which the second test method is applied, the second test method including selecting a detection result of a test item among reaction results of the plurality of reaction units 225, the controller 330 first stores detection results of a first reaction unit and a second reaction unit.

When the second test method is applied to the reactor 200, respective pieces of indicator paper accommodated in the plurality of reaction units 225 have different detection ranges with respect to the same test item. For example, a detection range of the second reaction unit may be greater than a detection range of the first reaction unit. For convenience of explanation, a description will be given of the second indicator paper having the detection range greater than the detection range of the first indicator paper.

The controller 330 determines whether the detection result of the first reaction unit is outside of a reference range. In this regard, the reference range may be set within the detection range of the first reaction unit and may be pre-stored in the tag or a memory (not shown) of the test apparatus. When the detection result of the first reaction unit is within the reference range, the controller 330 determines the detection result of the first reaction unit as the detection result of the test item and displays the detection result of the first reaction unit on the display unit.

When the detection result of the first reaction unit is outside of the reference range, the controller 330 determines the detection result of the second reaction unit as the detection result of the test item and displays the detection result of the second reaction unit on the display unit. Using detection results of two reaction units is described herein by way of example. However, the detection range of one test item may be enlarged by using detection results of two or more reaction units having different detection ranges.

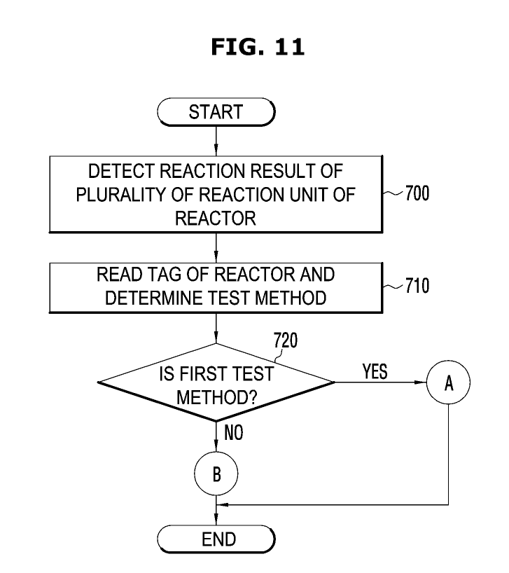

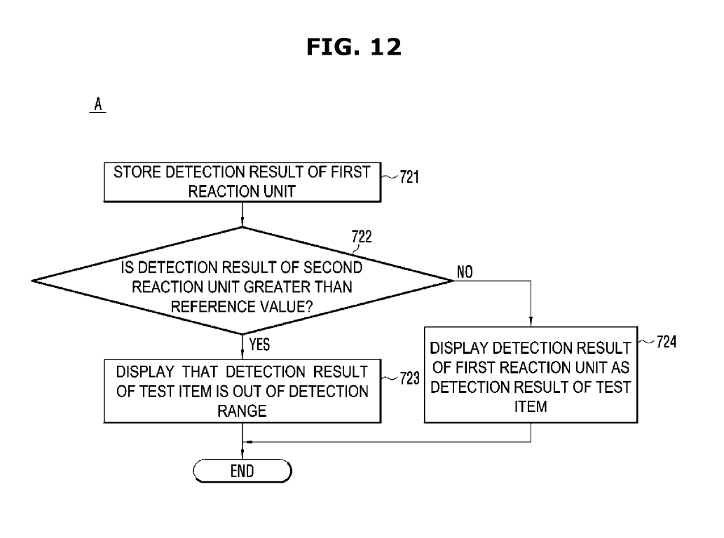

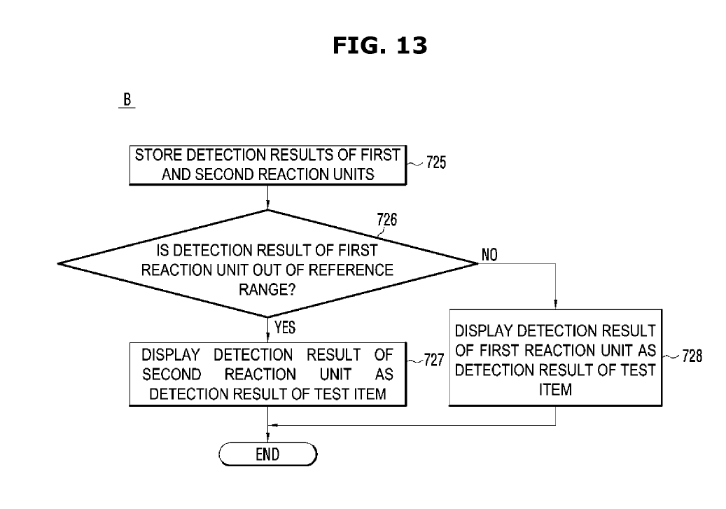

FIGS. 11, 12, and 13 are flowcharts illustrating a method for controlling a test apparatus, according to an exemplary embodiment. Hereinafter, a description will be given of a disc-type reactor as an examples of the reactor and a test apparatus performing a test by using the disc-type reactor as an example of the test apparatus for convenience of explanation.

Referring to FIGS. 11, 12, and 13, in operation 700, if the reactor 10 is inserted into the test apparatus, the detection module of the test apparatus detects reaction results of a plurality of reaction units of the reactor 10, and in operation 710, the controller 54 reads the tag 30 of the reactor 10 and determines a test method of the reactor 10.

The controller 54 controls driving of the rotary drive unit 56 so as to rotate the reactor 10 and controls driving of the detection module driving unit 57 so as to move the detection module 59 in a radial direction, so that the light receiving unit 59a respectively detects the tag 30 and the reaction units.

When the light receiving unit 59a acquires an image of the tag 30, the controller 54 reads the tag 30 and identifies the type of the reactor 10. If the reactor 10 is a reactor which includes a plurality of reaction units configured to detect a same test item, the controller 54 calculates a detection result of the test item based on detection results of the plurality of the reaction units 225 detected by the light receiving unit 343. The detection results of the reaction units configured to respectively detect different test items are not reliable when the detection result of each of the reaction units is outside of a detection range or a concentration lower than an actual concentration of the test item is calculated due to the hook effect. Accordingly, since the reactor 10 according to the illustrated exemplary embodiment includes a plurality of reaction units configured to detect the same test item, the test apparatus achieves the detection result of the test item from which the error or concentration reduction is removed by using the detection results of the plurality of reaction units.

In operation 720, the controller 54 determines whether the test method of the reactor 10 is the first test method as a result of reading of the tag 30. If the test method of the reactor 10 is determined to be the first test method (A), then in operation 721, the controller 54 stores the detection result of the first reaction unit 150-1.

As a result of reading of the tag 30, if the reactor 10 is a reactor to which the first test method is applied, the first test method including determining whether there is a detection error caused by the hook effect by using reaction results of the plurality of reaction units, and determining the detection result of the test item in accordance therewith, the controller 54 first stores the detection result of the first reaction unit 150-1.

The controller 54 determines whether the detection result of the second reaction unit 150-2 corresponds to a value which is greater than a reference value in operation 722, displays that the value corresponding to the detection result of the test item is greater than the reference range if the detection result of the second reaction unit 150-2 is greater than the reference value in operation 723, and displays the detection result of the first reaction unit 150-1 as the detection result of the test item if the value corresponding to detection result of the second reaction unit 150-2 is equal to or less than the reference value in operation 724.

In order to determine whether the detection result of the first reaction unit 150-1 is reduced by the hook effect, the controller 54 uses the detection result of the second reaction unit 150-2 as an auxiliary element. In order to determine whether the detection result of the first indicator paper is reduced by the hook effect, the second indicator paper may include a capture material, e.g., an antibody, at a high concentration on the test line 21 to capture the test item having a high concentration.

When the value corresponding to the detection result of the second reaction unit 150-2 is less than a reference value, the controller 54 determines that the detection result of the first reaction unit 150-1 does not have an error caused by the hook effect and determines the detection result of the first reaction unit 150-1 as the detection result of the test item. Then, the controller 54 displays the result on the display unit of the test apparatus. When the value corresponding to the detection result of the second reaction unit 150-2 is greater than the reference value, the controller 54 determines that the detection result of the first reaction unit 150-1 is outside of the detection range detectable by the first indicator paper and displays, on the display unit of the test apparatus, that the detection result of the test item is outside of the detection range.

If the detection result of the second indicator paper, which is configured to detect a range outside of the detection range of the first indicator paper without having the hook effect, is similar to the detection result of the first indicator paper, the detection result of the first reaction unit 150-1 may be determined as a normal value. However, if the value corresponding to the detection result of the second indicator paper is greater than the value corresponding to the detection result of the first indicator paper by a predetermined value or greater, it may be determined that the detection result of the first indicator paper has an error. The hook effect generally occurs when a sample includes a test item at a very high concentration. The reference value used to determine the existence of the hook effect may be set as a value similar to an upper limit of the detection range of the first indicator paper.

If the test method of the reactor 10 is determined as not being the first test method (B), then in operation 725, the controller 54 stores the detection results of the first reaction unit 150-1 and the second reaction unit 150-2.

If the test method of the reactor is determined as not being the first test method as a result of reading of the tag 30, the controller 54 determines that the test method of the reactor 10 is the second test method including selecting the detection result of the test item among reaction results of a plurality of reaction units, and stores the detection results of the first reaction unit 150-1 and the second reaction unit 150-2.

The controller 54 determines whether the detection result of the first reaction unit 150-1 is outside of a reference range in operation 726, displays the detection result of the second reaction unit 150-2 as the detection result of the test item if the detection result of the first reaction unit 150-1 is outside of the reference range in operation 727, and displays the detection result of the first reaction unit 150-1 as the detection result of the test item if the detection result of the first reaction unit is within the reference range in operation 728.

When the second test method is applied to the reactor 10, respective pieces of indicator paper accommodated in the plurality of reaction units have different detection ranges with respect to the same test item. For example, the detection range of the second reaction unit 150-2 may be greater than the detection range of the first reaction unit 150-1. For convenience of explanation, a description will be given of the second indicator paper which has a detection range which is greater than the detection range of the first indicator paper.

The controller 54 determines whether the detection result of the first reaction unit 150-1 is out of the reference range. In this regard, the reference range may be set within the detection range of the first reaction unit 150-1 and may be pre-stored in the tag 30 and/or a memory (not shown) of the test apparatus. When the detection result of the first reaction unit 150-1 is within the reference range, the controller 54 determines the detection result of the first reaction unit 150-1 as the detection result of the test item and displays the detection result of the first reaction unit 150-1 on the display unit.

When the detection result of the first reaction unit 150-1 is outside of the reference range, the controller 54 determines the detection result of the second reaction unit 150-2 as the detection result of the test item and displays the detection result of the second reaction unit 150-2 on the display unit. Using the detection results of two reaction units is described herein by way of example. However, the detection range of the test item may be enlarged by using detection results of two or more reaction units which have different respective detection ranges.

As is apparent from the above description, reliability of the detection result of the test item may be improved by using the detection results of at least two reaction units to detect one single test item.

Since the detection result of the test item is obtained by using the detection results of the plurality of reaction units which have different respective detection ranges, a separate test is not required when the detection result of the test item is outside of the detection range of the reaction unit.

Although a few exemplary embodiments have been shown and described, it will be appreciated by those skilled in the art that changes may be made in these exemplary embodiments without departing from the principles and spirit of the present inventive concept, the scope of which is defined in the claims and their equivalents.

What is claimed is:

1. A test apparatus comprising:
a detector configured to detect reaction results obtained by each of a plurality of reaction modules which are provided in a reactor in order to discern a first test item; and
a controller configured to calculate a test result of the first test item by using detection results obtained by at least two reaction modules from among detection results detected by the detector.

2. The test apparatus according to claim 1, wherein the controller is further configured to store a detection result obtained by a first reaction module of the reactor and to determine the stored detection result obtained by the first reaction module as a detection result which indicates the first test item when a detection result obtained by a second reaction module of the reactor corresponds to a value which is less than a reference value.

3. The test apparatus according to claim 2, wherein the controller is further configured to determine that the detection result which indicates the first test item is outside of a detection range when the corresponding value of the detection result obtained by the second reaction module is greater than the reference value.

4. The test apparatus according to claim 1, wherein the controller is further configured to store detection results obtained by a first reaction module and a second reaction module of the reactor and to determine the detection result obtained by the first reaction module as a detection result which indicates the first test item when the detection result obtained by the first reaction module of the reactor corresponds to a value which is within a reference range.

5. The test apparatus according to claim 4, wherein the controller is further configured to determine the detection result obtained by the second reaction module as the detection result which indicates the first test item when the corresponding value of the detection result obtained by the first reaction module is outside of the reference range.

6. The test apparatus according to claim 4, wherein a detection range of the second reaction module has a scope which is greater than a corresponding scope of a detection range of the first reaction module.

7. A reactor comprising:
a plurality of reaction modules configured to detect a first test item; and
a tag comprising at least one from among identification information which identifies the reactor and information which relates to a method for detecting the first test item.

8. The reactor according to claim 7, wherein at least one from among the plurality of reaction modules comprises at least one from among an indicator paper and a chamber which comprises a reactant configured to detect the first test item.

9. The reactor according to claim 7, wherein the information which relates to the method comprises information which relates to at least one test method from among a plurality of predetermined different test methods for detecting the first test item.

10. The reactor according to claim 7, wherein the at least one from among the identification information which identifies the reactor and information which relates to the method comprises at least one from a bar code, a quick response (QR) code, and a radio frequency identification (RFID) tag.

11. The reactor according to claim 7, wherein the reactor comprises a microfluidic apparatus and a cartridge reactor.

12. A reactor comprising:
a platform;
a plurality of reaction modules disposed on the platform and configured to detect a first test item; and
a tag, disposed on the platform, comprising at least one from among identification information which identifies the reactor and information which relates to a method for detecting the first test item.

13. A method for controlling a test apparatus, the method comprising:
detecting respective reaction results obtained by each of a plurality of reaction modules which are provided in a reactor for detecting a first test item; and
calculating a test result of the first test item by using detection results obtained by at least two reaction modules from among the detected reaction results.

14. The method according to claim 13, wherein the calculating the test result comprises:
storing a detection result obtained by a first reaction module of the reactor;
determining whether a detection result obtained by a second reaction module of the reactor corresponds to a value which is greater than a reference value; and
determining the stored detection result obtained by the first reaction module as the test result of the first test item when the corresponding value of the detection result obtained by the second reaction module is equal to or less than the reference value.

15. The method according to claim 14, further comprising determining that the detection result of the first test item is outside of a detection range when the corresponding value of the detection result of the second reaction module is greater than the reference value.

16. The method according to claim 13, wherein the calculating the test result comprises:
storing detection results obtained by a first reaction module and a second reaction module of the reactor;
determining whether the detection result obtained by the first reaction module is outside of a reference range; and
determining the stored detection result obtained the first reaction module as the test result which indicates the first test item when the detection result obtained by the first reaction module is determined as being within the reference range.

17. The method according to claim 16, further comprising determining the stored detection result obtained by the second reaction module as the test result which indicates the first test item when the detection result obtained by the first reaction module is determined as being outside of the reference range.

18. A non-transitory computer readable recording medium storing a program which is executable by a computer for performing the method according to claim 13.
